(19) United States
(12) Patent Application Publication
(10) Pub. No.: US 2006/0027072 A1
(43) Pub. Date: Feb. 9, 2006

(54) Cymbal snaps

(76) Inventor: Robert S. Morelli, Mahopac, NY (US)

Correspondence Address: PRECISION ENHANCED PRODUCTS, INC., 15 SECOR ROAD, MAHOPAC, NY, 10541, US

(21) Appl. No.: 10/891,730

(22) Filed: Jul. 15, 2004

(51) Int. Cl. G10D 13/02

(52) U.S. Cl. 84/422.3

(57) ABSTRACT

Nylon snap together sleeves that protect cymbals from damage and wear. Keeps felts and sleeves together on a cymbal allowing quick setups with no loose parts. This allows quick setups and breakdowns of cymbals on stands. Allows fine adjustment that does not change when playing. Increases felt life as Cymbal Snaps acts as a washer on both felts. Acts as a bushing that allows user to use cymbals with worn or damaged center hole.

### BACKGROUND OF INVENTION

The idea was to make two bushings that snapped together to use on an old cymbal with a worn out hole. This idea became a bushing that not only allowed the worn cymbal to be used but also worked as a plastic protector between the cymbal and the screw of the cymbal stand. Then I realized what a benefit it was to have the felts stay together with the Cymbals as the Cymbal Snaps hold everything together. Another benefit was having Cymbal Snaps act as a washer on top of the felts, as a result in protecting the felts against the wing nut of the Cymbal Stand, but also being able to adjust the cymbal tension from firm to lose.

### ASSEMBLY DETAIL

FIG. 1

A Cymbal Snap Top

B Felt washers

C Cymbal

D Cymbal Snap Bottom

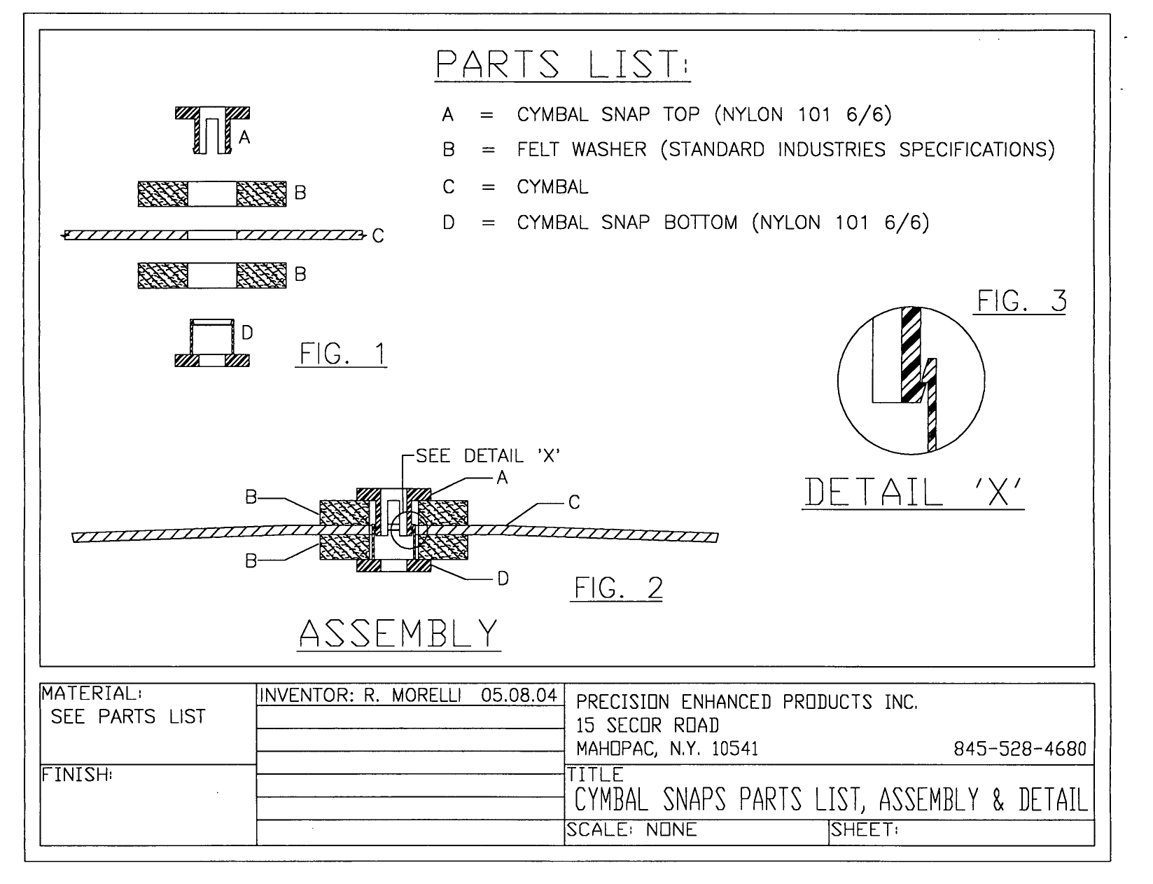

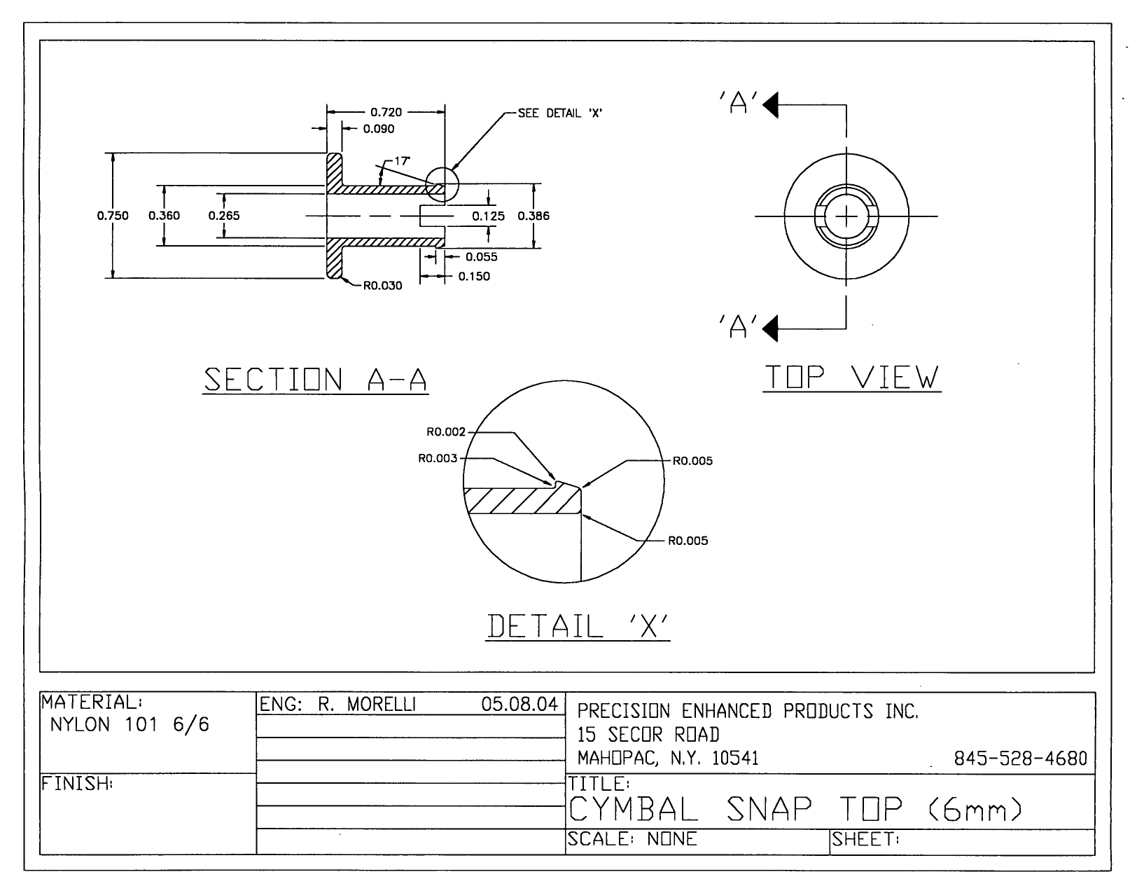

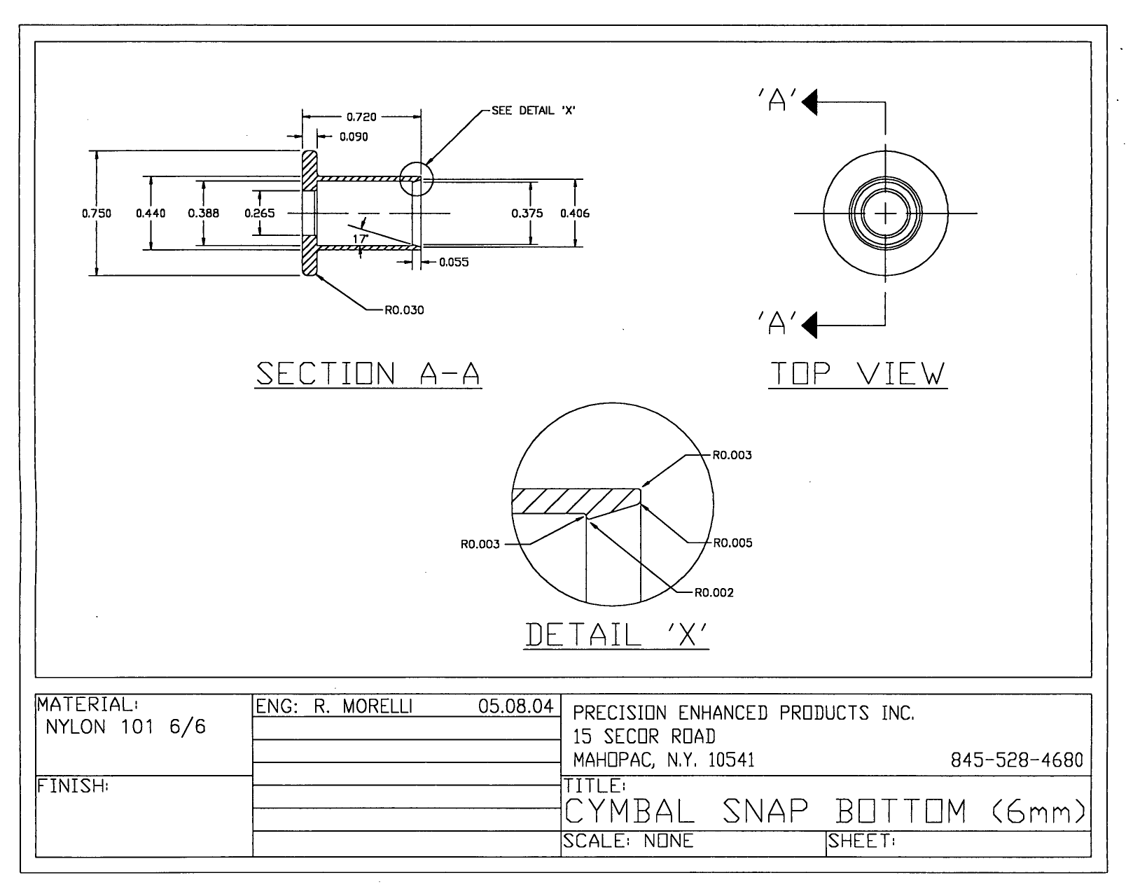

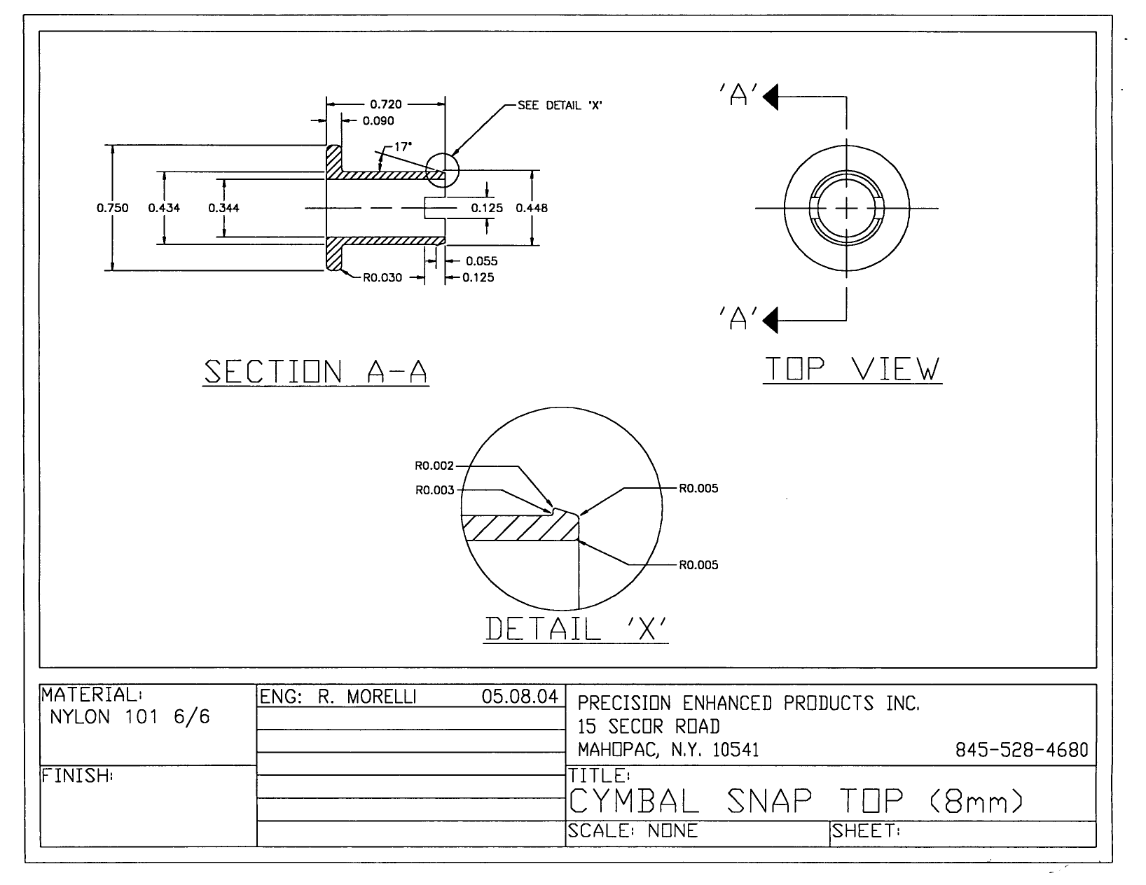

FIG. 2 Shows Cymbal Snap top (A) assembled to Cymbal Snap bottom (D) with felts (B) and cymbal (C).

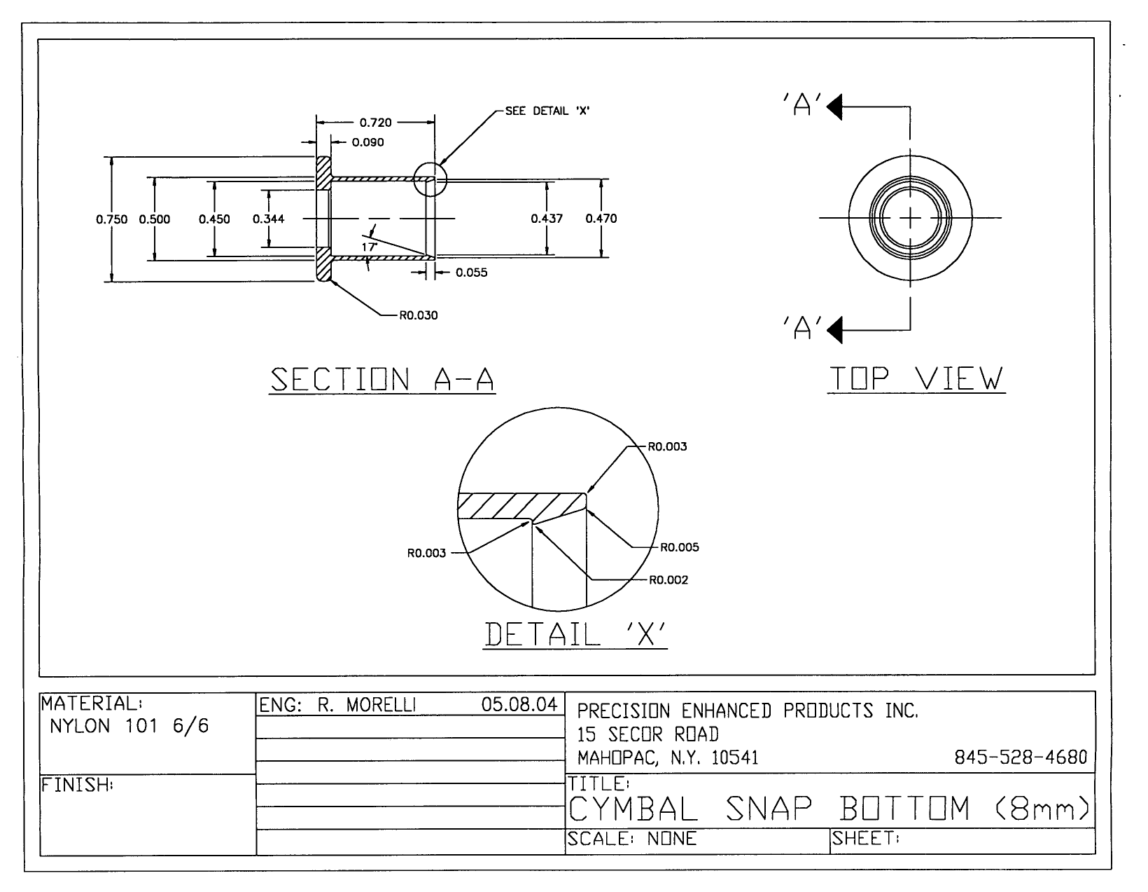

FIG. 3 Shows detail of locking snap between Cymbal snap top (A) and Cymbal snap bottom (D) This radial interlock is easily assembled by hand pressure and can be removed by snapping the two apart. Two slots provide spring to allow this connection to be made by hand pressure.

### CROSS REFERENCE TO RELATED APPLICATIONS

| Patent No. | Date Of Patent |
|---|---|
| 3994198 | Nov. 30, 1976 |
| 4216695 | Aug. 12, 1980 |
| 4319514 | Mar. 16, 1982 |
| 4365535 | Dec. 28, 1982 |
| 4526083 | Jul. 2, 1985 |
| 4960028 | Oct. 2, 1990 |
| 5121665 | Jun. 16, 1992 |
| 5482235 | Jan. 9, 1996 |
| 5934629 | Aug. 10, 1999 |
| 5808217 | Sep. 15, 1998 |
| 6239343 | May 29, 2001 |

1. Cymbal Snap protector comprising of a plastic top with a shoulder and an plastic bottom with a shoulder which snap together using iniatrical locking mechanism used to protect cymbal from wear.

2. In combination of claim 1 wherein the Cymbal Snap protector keeps the felt together on the cymbal preventing loss of the felts and allowing quicker setup when attaching cymbals on cymbal stands.

3. Friction between the Cymbal Snap protector top and the Cymbal Snap protector bottom allows the complete assembly consisting of cymbal snaps, felts, and cymbal to spin between the cymbal stand threaded post and wing nut when played under relaxed tension.

4. Plastic bearing surface of Cymbal Snap protector top allows smooth and easy adjustment of wing nut tension to compress felts to cymbals. This increases life of the felt, as there is no abrasion to the felt from the wing nut.

5. Cymbal Snaps supports and reinforce the cymbal hole which provides less probability of cymbal hole wear.

6. Cymbal Snaps allows the use of cymbals with center hole damaged or worn from playing without protection to play like a cymbal with a new round center hole.
